(19) United States
(12) Patent Application Publication
(10) Pub. No.: US 2019/0370816 A1
(43) Pub. Date: Dec. 5, 2019

(54) BLOCKCHAIN-BASED MERCHANDISE TRACING METHODS AND APPARATUS

(71) Applicant: Alibaba Group Holding Limited, George Town (KY)

(72) Inventor: Danqing Hu, Hangzhou (CN)

(73) Assignee: Alibaba Group Holding Limited, George Town (KY)

(21) Appl. No.: 16/425,061

(22) Filed: May 29, 2019

(30) Foreign Application Priority Data
May 29, 2018 (CN) 201810533956.6

(51) Int. Cl. G06Q 30/00; H04L 9/08; G06Q 20/40

(52) U.S. Cl. CPC G06Q 30/018; G06Q 2220/00; G06Q 20/401; H04L 9/088

(57) ABSTRACT

A computer-implemented method for tracing blockchain-based merchandise is provided. The method includes collecting appearance data of target merchandise, and registering the appearance data of the target merchandise in a distributed database of a blockchain as an identity of the target merchandise. The method includes retrieving, from the distributed database of the blockchain, a merchandise record that is stored and that is associated with the identity indicated by the appearance data of the target merchandise, and performing merchandise tracing on the merchandise record to complete a merchandise tracing for the target merchandise.

### CROSS-REFERENCE TO RELATED APPLICATIONS

This application claims priority to Chinese Patent Application No. 201810533956.6, filed on May 29, 2018, which is hereby incorporated by reference in its entirety.

### TECHNICAL FIELD

One or more implementations of the present specification relate to the field of blockchain technologies, and in particular, to blockchain-based merchandise tracing methods and apparatus, and an electronic device.

### BACKGROUND

A blockchain technology is also referred to as a distributed ledger technology, and is an emerging technology that several computing devices jointly participate in “accounting” and jointly maintain a complete distributed database. The blockchain technology is decentralized and transparent. Also, in the blockchain technology, each computing device can participate in database recording, and can quickly perform data synchronization. Therefore, the blockchain technology is used to build decentralized systems, and collect various execution programs in a distributed database of a blockchain for automatic execution. As such, the blockchain technology has been widely used in many fields.

### SUMMARY

The present specification provides a blockchain-based merchandise tracing method, including the following: collecting appearance data of target merchandise, and registering the appearance data of the target merchandise in a distributed database of a blockchain as an identity of the target merchandise; searching the distributed database of the blockchain for a merchandise record that is stored and that is associated with the identity indicated by the appearance data of the target merchandise; and performing merchandise tracing processing on the found merchandise record to complete merchandise tracing for the target merchandise.

Optionally, the registering the appearance data of the target merchandise in a distributed database of a blockchain as an identity of the target merchandise includes the following: performing, in the distributed database of the blockchain, storage on the appearance data of the target merchandise that is associated with the identity of the target merchandise that has been registered in the blockchain.

Optionally, the method further includes the following: obtaining a merchandise record that is generated by an operator of the target merchandise and that corresponds to the target merchandise; and publishing the merchandise record and the appearance data of the target merchandise to the blockchain, to perform, in the distributed database of the blockchain, storage on the merchandise record that is associated with the identity indicated by the appearance data of the target merchandise.

Optionally, the performing merchandise tracing processing on the found merchandise record includes the following: invoking a smart contract that corresponds to the target merchandise, executing merchandise tracing logic stated in the smart contract, and performing merchandise tracing processing on the found merchandise record.

Optionally, the merchandise record includes a merchandise production record signed by a producer of the target merchandise based on a private key, and the merchandise tracing includes merchandise anti-counterfeiting tracing; and the performing merchandise tracing processing on the found merchandise record includes the following: performing verification on a signature of the merchandise production record based on a public key of the producer of the target merchandise; and determining that merchandise anti-counterfeiting tracing for the target merchandise succeeds if the verification succeeds.

Optionally, the merchandise record includes a merchandise circulation record signed by a plurality of merchandise circulation parties on a circulation channel of the target merchandise based on a private key, and the merchandise tracing includes merchandise circulation channel tracing; and the performing merchandise tracing processing on the found merchandise record includes the following: performing verification on a signature of the merchandise circulation record based on a public key of the plurality of merchandise circulation parties on the circulation channel of the target merchandise; and if the verification succeeds, generating a merchandise circulation sequence of the target merchandise in the plurality of merchandise circulation parties, and verifying whether the merchandise circulation sequence matches a predetermined legal circulation sequence; and if yes, determining that merchandise circulation channel tracing for the target merchandise succeeds.

Optionally, a timestamp used to indicate a circulation sequence of the target merchandise is recorded in the merchandise circulation record; and the generating a merchandise circulation sequence of the target merchandise in the plurality of merchandise circulation parties includes the following: obtaining the timestamp recorded in the merchandise circulation record; and generating the merchandise circulation sequence of the target merchandise based on the obtained timestamp.

Optionally, the outer surface of the target merchandise is sprayed with an optical medium used to solidify the appearance data of the target merchandise; and the collecting appearance data of target merchandise includes the following: collecting, by using a mounted optical sensor, the appearance data of the target merchandise solidified by using the optical medium.

Optionally, the optical medium is a nano-optical film.

Optionally, the blockchain is a consortium blockchain.

The present specification further provides a blockchain-based merchandise tracing apparatus, including the following: a collection module, configured to collect appearance data of target merchandise, and register the appearance data of the target merchandise in a distributed database of a blockchain as an identity of the target merchandise; a searching module, configured to search the distributed database of the blockchain for a merchandise record that is stored and that is associated with the identity indicated by the appearance data of the target merchandise; and a tracing module, configured to perform merchandise tracing processing on the found merchandise record to complete merchandise tracing for the target merchandise.

Optionally, the apparatus further includes the following: a registration module, configured to perform, in the distributed database of the blockchain, storage on the appearance data of the target merchandise that is associated with the identity of the target merchandise that has been registered in the blockchain.

Optionally, the apparatus further includes the following: an acquisition module, configured to obtain a merchandise record that is generated by an operator of the target merchandise and that corresponds to the target merchandise; and a publishing module, configured to publish the merchandise record and the appearance data of the target merchandise to the blockchain, to perform, in the distributed database of the blockchain, storage on the merchandise record that is associated with the identity indicated by the appearance data of the target merchandise.

Optionally, the tracing module is further configured to: invoke a smart contract that corresponds to the target merchandise, execute merchandise tracing logic stated in the smart contract, and perform merchandise tracing processing on the found merchandise record.

Optionally, the merchandise record includes a merchandise production record signed by a producer of the target merchandise based on a private key, and the merchandise tracing includes merchandise anti-counterfeiting tracing; and the tracing module is further configured to: perform verification on a signature of the merchandise production record based on a public key of the producer of the target merchandise; and determine that merchandise anti-counterfeiting tracing for the target merchandise succeeds if the verification succeeds.

Optionally, the merchandise record includes a merchandise circulation record signed by a plurality of merchandise circulation parties on a circulation channel of the target merchandise based on a private key, and the merchandise tracing includes merchandise circulation channel tracing; and the tracing module is further configured to: perform verification on a signature of the merchandise circulation record based on a public key of the plurality of merchandise circulation parties on the circulation channel of the target merchandise; and if the verification succeeds, generate a merchandise circulation sequence of the target merchandise in the plurality of merchandise circulation parties, and verify whether the merchandise circulation sequence matches a predetermined legal circulation sequence; and if yes, determine that merchandise circulation channel tracing for the target merchandise succeeds.

Optionally, a timestamp used to indicate a circulation sequence of the target merchandise is recorded in the merchandise circulation record; and the tracing module is further configured to: obtain the timestamp recorded in the merchandise circulation record; and generate the merchandise circulation sequence of the target merchandise based on the obtained timestamp.

Optionally, the outer surface of the target merchandise is sprayed with an optical medium used to solidify the appearance data of the target merchandise; and the collection module is further configured to: collect, by using a mounted optical sensor, the appearance data of the target merchandise solidified by using the optical medium.

Optionally, the optical medium is a nano-optical film.

Optionally, the blockchain is a consortium blockchain.

The present specification further provides an electronic device, including the following: a processor; and a memory, configured to store a machine executable instruction, where by reading and executing the machine executable instruction that is stored in the memory and that corresponds to control logic of blockchain-based merchandise tracing, the processor is configured to: collect appearance data of target merchandise, and register the appearance data in a distributed database of a blockchain as an identity of the target merchandise; receive a target transaction initiated by a member node device in the blockchain, where the target transaction includes the appearance data of the target merchandise collected by the member node device and a service event detected by the member node device and associated with the target merchandise; and invoke a smart contract that corresponds to the service event, and execute service logic stated in the smart contract based on the identity indicated by the appearance data of the target merchandise.

### BRIEF DESCRIPTION OF DRAWINGS

FIG. 1 is a flowchart illustrating a blockchain-based merchandise tracing method, according to an example implementation;

FIG. 2 is a schematic structural diagram illustrating an electronic device, according to an example implementation;

FIG. 3 is a block diagram illustrating a blockchain-based merchandise tracing apparatus, according to an example implementation; and

FIG. 4 is a flowchart illustrating an example of a computer-implemented method for blockchain-based merchandise tracing, according to an implementation of the present disclosure.

### DESCRIPTION OF IMPLEMENTATIONS

The present specification aims to provide technical solutions in which appearance data of a merchandise is registered in a blockchain as an identity of the merchandise, and merchandise tracing is performed on the merchandise based on a merchandise record that is stored in the blockchain and that corresponds to the identity indicated by the appearance data of the target merchandise.

In an implementation, an operator of a merchandise can join a blockchain in advance as a member of the blockchain. For example, the blockchain can be a consortium blockchain, and the operator of the merchandise can include a producer of the merchandise (for example, a manufacturer) and a merchandise circulation party (for example, an intermediary of a merchandise circulation intermediate link) on a circulation channel of the merchandise.

Further, the producer of the merchandise and the merchandise circulation party on the circulation channel of the merchandise can join the consortium blockchain as members of the consortium blockchain.

The operator of the merchandise can collect appearance data of the merchandise in advance, and register appearance data of target merchandise in a distributed database of the blockchain as the appearance data of the merchandise.

Moreover, the operator of the merchandise can generate a corresponding merchandise record in various traceable links such as merchandise production and circulation, publish the generated merchandise record to the blockchain as source data for merchandise tracing by using a node device accessing the blockchain, and perform, in the distributed database of the blockchain, storage on the merchandise record that is associated with the identity indicated by the appearance data of the merchandise.

The node device that needs to perform merchandise tracing on the target merchandise in the blockchain can collect the appearance data of the target merchandise, and search the distributed database of the blockchain based on the collected appearance data for a merchandise record that corresponds to the identity indicated by the appearance data of the target merchandise in the distributed database of the blockchain, and perform merchandise tracing processing on the found merchandise record to complete merchandise tracing for the target merchandise.

In the previously described technical solutions, because the blockchain is characterized by historical traceability and cannot be tampered with, the merchandise record generated by the operator of the merchandise in the various traceable links such as merchandise production and circulation can be truly recorded in the blockchain by using such the method, and all merchandise records can be traced in the blockchain. In addition, because the merchandise record is jointly maintained by a plurality of node devices in the blockchain, the merchandise record cannot be tampered with unless most node devices are controlled, so as to ensure impartiality of the generated merchandise record.

Moreover, because the appearance data of the target merchandise is easy to collect, the appearance data of the target merchandise is registered in the distributed database of the blockchain as the identity of the target merchandise, and storage is performed on the merchandise record generated by the operator of the merchandise in the various traceable links such as merchandise production and circulation that is associated with the identity indicated by the appearance data of the target merchandise, so that when merchandise tracing needs to be performed on the target merchandise, the identity of the target merchandise in the blockchain can be specified by collecting the appearance data of the merchandise. Therefore, the blockchain can be searched based on the specified identity to quickly obtain the corresponding merchandise record, and complete merchandise tracing for the target merchandise, improving tracing efficiency of performing merchandise tracing on the target merchandise.

The following describes the present specification with reference to specific application scenarios by using specific implementations.

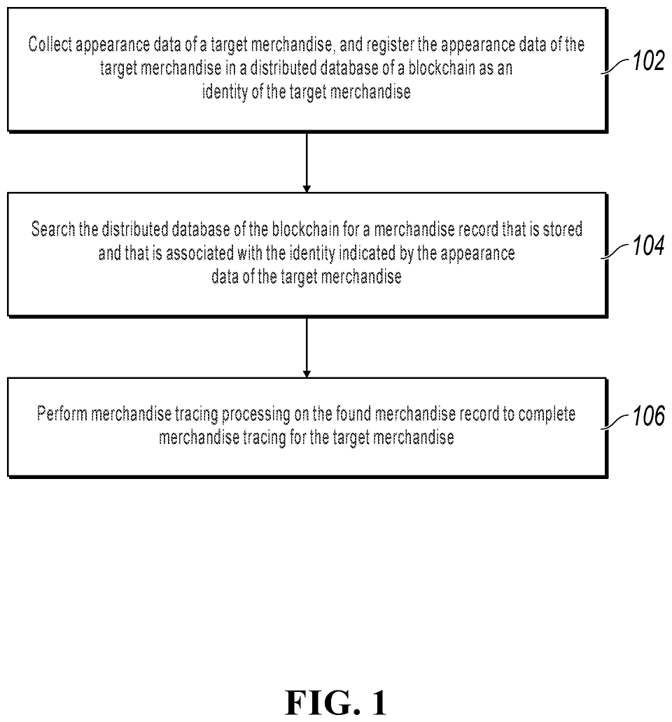

FIG. 1 shows a blockchain-based merchandise tracing method according to an implementation of the present specification. The method is applied to any node device in a blockchain, and includes the following steps.

Step 102: Collect appearance data of target merchandise, and register the appearance data of the target merchandise in a distributed database of a blockchain as an identity of the target merchandise.

Step 104: Search the distributed database of the blockchain for a merchandise record that is stored and that is associated with the identity indicated by the appearance data of the target merchandise.

Step 106: Perform merchandise tracing processing on the found merchandise record to complete merchandise tracing for the target merchandise.

The target merchandise can include any type of merchandise having unique and fixed appearances. In actual applications, a producer of the merchandise can add a unique identifier and imprint to the outer surface of the merchandise to ensure that the appearance of the merchandise is unique. In addition, the producer of the merchandise can transform the merchandise into a smart device by placing a chip, a sensor, or another form of smart hardware inside the merchandise, and the smart device can be configured to access the blockchain as a member node device.

Correspondingly, the blockchain described in the present specification can include any type of blockchain network that allows the merchandise to be accessed as a member.

For example, in one scenario, the blockchain can be a consortium blockchain that includes terminal devices of merchandise producers, terminal devices of merchandise circulation parties such as providers and intermediaries at all levels on a merchandise circulation channel, and mobile terminal devices of several common consumers. An operator of the consortium blockchain can use the consortium blockchain to deploy an online service that merchandise tracing is performed based on the identity indicated by the appearance data of the merchandise. Any provider, intermediary, or common consumer other than the producer in the consortium blockchain can perform merchandise tracing on the merchandise that has completed identity registration in the blockchain, by using the accessed member node device.

The merchandise record can include a data record that is generated by the operator of the merchandise in various traceable links such as merchandise production and circulation and that can be used as source data for merchandise tracing.

For example, the operator of the merchandise can include the producer of the merchandise, merchandise circulation parties at all levels on the merchandise circulation channel, and the data record can include a merchandise production record generated by the producer of the merchandise, a merchandise circulation record generated by the merchandise circulation party, etc.

The merchandise tracing can include merchandise anti-counterfeiting tracing for the merchandise that has completed identity registration in the blockchain and merchandise circulation channel tracing.

The merchandise anti-counterfeiting tracing is a process of tracing whether the merchandise is a fake product based on the merchandise record stored in the blockchain. The merchandise circulation channel tracing is a process of tracking whether the merchandise circulation channel is a legal circulation channel based on the merchandise record stored in the blockchain.

An example that the blockchain is the consortium blockchain is used below to describe the technical solutions of the present specification in detail by using specific implementations.

In the present specification, the operator of the consortium blockchain can set up a consortium blockchain, and merchandise producers, merchandise circulation parties such as providers and intermediaries at all levels on the merchandise circulation channel, and common consumers can join the consortium blockchain as members.

The merchandise producer and the merchandise circulation party serving as nodes that have “accounting permission” can write the merchandise record generated in various traceable links such as merchandise production and circulation to the distributed database (that is, a distributed ledger) of the consortium blockchain. The common consumer serving as a node that has no “accounting permission” can initiate merchandise tracing based on the merchandise record stored in the distributed database of the blockchain.

In the present specification, the operator of the consortium blockchain can use a specific architecture of the consortium blockchain to deploy a merchandise tracing service in the consortium blockchain.

In an illustrated implementation, the operator of the consortium blockchain can deploy the merchandise tracing service by publishing a smart contract associated with the merchandise tracing service to the consortium blockchain. In this case, the operator can pre-develop the smart contract associated with the merchandise tracing service, and state merchandise tracing logic that needs to be triggered in the smart contract.

The merchandise tracing logic stated in the smart contract is not limited to what is described in the present specification, and can be customized by the operator of the consortium blockchain based on an actual service need.

For example, if the merchandise tracing is merchandise anti-counterfeiting tracing, the merchandise tracing logic stated in the smart contract can be logic used to verify whether the traced merchandise is a fake product based on the merchandise record stored in the consortium blockchain. If the merchandise tracing is merchandise circulation channel tracing, the merchandise tracing logic stated in the smart contract can be logic used to verify whether the merchandise circulation channel is a legal merchandise circulation channel based on the merchandise record stored in the consortium blockchain.

Further, for a developed smart contract, the operator can publish the smart contract to the consortium blockchain by using any node device in the consortium blockchain, and record the smart contract in the distributed database of the consortium blockchain after some specified member node devices in the consortium blockchain (for example, several node devices having accounting permission that are specified in the consortium blockchain) reach a consensus on the smart contract.

Subsequently, the common consumer can access any node device by using a client, and submit a transaction (transfer) to the smart contract recorded in the consortium blockchain, to invoke the smart contract and trigger related merchandise tracing logic in the consortium blockchain.

It is worthwhile to note that a consensus algorithm and a specific consensus process used when the member node devices in the consortium blockchain perform consensus processing on the smart contract published to the blockchain are not described in detail in the present specification. A person skilled in the art can refer to records in related technologies when implementing the technical solutions in the present specification.

For example, the consortium blockchain can use a Practical Byzantine Fault Tolerance (PBFT) algorithm or another similar consensus algorithm.

In some exemplary applications, the operator of the consortium blockchain can deploy the merchandise tracing service by using a method other than publishing the smart contract associated with the merchandise tracing service to the consortium blockchain. For example, in an implementation, a node having “accounting permission” such as the merchandise producer or the merchandise circulation party can write service information used for merchandise tracing to the generated merchandise record. In this case, the operator does not necessarily deploy the smart contract associated with the merchandise tracing service in the consortium blockchain. When the common consumer needs to perform merchandise tracing, the common consumer can independently complete merchandise tracing by using information recorded in the merchandise record stored in the consortium blockchain.

In the present specification, the producer of the merchandise can transform the merchandise into a smart transportation device by placing a chip, a sensor, or another form of smart hardware inside the merchandise, and the smart transportation device accesses the consortium blockchain as a member node device (in other words, the merchandise “accesses the chain”).

In an illustrated implementation, a private key and public key generation algorithm can be further placed in the chip, the sensor, or another form of smart hardware placed in the merchandise. When the merchandise accesses the consortium blockchain as a member node device, a private key and a public key can first be generated by invoking the key algorithm.

Then, a transaction used to initiate registration can be further generated, and the transaction is published to the consortium blockchain after being signed based on the generated private key, to apply for joining the consortium blockchain. After receiving the transaction, some specified member node devices in the consortium blockchain can verify a signature of the transaction based on a public key corresponding to the private key used to sign the transaction, and can perform consensus processing on the transaction after the signature verification succeeds.

When a consensus on the transaction is reached, a public key of the merchandise can be calculated to generate an identity (for example, an account address or an access address) for the merchandise in the consortium blockchain. In this case, the merchandise successfully joins the consortium blockchain as a member node device, and the identity generated for the merchandise is an identity of the member node device in the consortium blockchain.

In some exemplary applications, after the merchandise joins the consortium blockchain, the identity generated by the consortium blockchain for the merchandise can be an identity of the merchandise in the consortium blockchain. Therefore, when the common consumer initiates merchandise tracing for target merchandise by using an accessed node device, the node device needs to quickly obtain an identity of the target merchandise in the consortium blockchain.

For example, in implementation, the node device can obtain the identity generated for the merchandise by performing short-range wireless communication with the chip, the sensor, or another form of smart hardware placed in the merchandise. However, in short-range wireless communication, there are risks that identity collection is not convenient enough, and the identity is possibly tampered with because the communication process is attacked.

In view of the above, in the present specification, the appearance data of the merchandise can be registered in the distributed database of the consortium blockchain as identity information of the merchandise in the consortium blockchain.

In an illustrated implementation, the producer of the merchandise can collect the appearance data of the merchandise by using an accessed member node device, perform storage on the identity of the merchandise in the consortium blockchain that is associated with the collected appearance data in the distributed database of the consortium blockchain, to register the appearance data of the merchandise in the existing identity of the merchandise in the consortium blockchain as the identity information of the merchandise.

In some exemplary applications, if the merchandise does not have an identity in the consortium blockchain, the appearance data of the merchandise can also be directly used as the identity of the merchandise in the consortium blockchain. For example, the appearance data of the merchandise can be used as a public key of the merchandise to calculate the appearance data of the merchandise and generate an identity in the consortium blockchain.

In an illustrated implementation, the outer surface of the merchandise can be pre-sprayed with an optical medium used to solidify the appearance data of the merchandise. Specific materials of the optical medium are not limited to those described in the present specification, and include but are not limited to any materials that can be sprayed on the outer surface of the merchandise and that are used to solidify the appearance data of the merchandise.

For example, in an implementation, the optical medium can be a nano-optical film. The nano-optical film can be made of nano-level carbon structural materials. After the carbon structural materials are sprayed on the outer surface of the merchandise, the merchandise can be wrapped to form a layer of nano-level optical film to automatically solidify the appearance data of the merchandise.

An optical sensor for collecting the appearance data of the merchandise solidified by using the nano-optical film can be mounted on the member node device in the consortium blockchain, and optical sensing is performed on the nano-optical film by using the optical sensor to collect the appearance data of the merchandise solidified by using the nano-optical film.

In addition to the illustrated implementation of spraying the optical medium on the merchandise to solidify and collect the appearance data of the merchandise, in some exemplary applications, other implementations can also be used to collect the appearance data of the merchandise, which are not listed one by one in the present specification.

For example, three-dimensional scanning can be further performed on the whole merchandise to accurately collect the appearance data of the merchandise; or an image of the merchandise can be collected by using a visual technology, and the appearance data of the merchandise can be calculated based on the collected image.

In another illustrated implementation, the producer of the merchandise and the merchandise circulation party in the consortium blockchain can generate a corresponding merchandise record in various traceable links such as merchandise production and circulation, and sign the merchandise record based on a private key.

The member node device accessed by the producer of the merchandise and the merchandise circulation party in the consortium blockchain can obtain the signed merchandise generated by the producer of the merchandise and the merchandise circulation party, publish the obtained merchandise record and the collected appearance data of the merchandise to the consortium blockchain, record them in the distributed database of the consortium blockchain after some specified member node devices in the consortium blockchain reach a consensus, and perform storage on the obtained merchandise record that is associated with the identity indicated by the appearance data of the merchandise in the distributed database of the consortium blockchain.

After the appearance data of the merchandise is registered in the distributed database of the consortium blockchain as the identity of the merchandise, and storage is performed on the identity indicated by the appearance data of the merchandise that is associated with the merchandise record generated by the producer of the merchandise and the merchandise circulation party for the merchandise and recorded in the distributed database of the consortium blockchain, when the common consumer subsequently needs to perform merchandise tracing on target merchandise, the common consumer can collect appearance data of the target merchandise by using an accessed member node device, and then search the consortium blockchain for the merchandise record that is stored and that is associated with an identity indicated by the appearance data of the target merchandise to complete merchandise tracing for the target merchandise.

An example that a consumer completes merchandise tracing of the target merchandise by invoking the smart contract is used below for description.

In the present specification, the operator of the consortium blockchain can develop a client used for merchandise tracing for consumers, and when a common consumer needs to perform merchandise tracing on target merchandise, the common consumer can access any member node device in the consortium blockchain by using the client to initiate merchandise tracing for the target merchandise.

In response to the merchandise tracing initiated by the common consumer for the target merchandise, the member node device can further collect the appearance data of the target merchandise to specify the identity of the target merchandise in the consortium blockchain.

For example, in an implementation, an operation portal for initiating merchandise tracing can be provided for the common consumer at the client, and the common consumer can trigger the member node device by using the operation portal to sense a nano-optical film sprayed on the outer surface of the merchandise and collect image data for the nano-optical film by using a mounted optical sensor.

Further, after collecting the appearance data of the target merchandise, the member node device can search the distributed database of the consortium blockchain based on the collected appearance data of the target merchandise for a merchandise record that is stored and that is associated with the identity indicated by the appearance data of the target merchandise, and then can invoke the smart contract that has been deployed in the consortium blockchain to trigger the merchandise tracing logic stated in the smart contract, and perform merchandise tracing processing on the merchandise record to complete merchandise tracing for the target merchandise.

It is worthwhile to note that the execution logic of the merchandise record that storage that is associated with the identity indicated by the appearance data of the target merchandise is performed on is described above, and can be independently executed by the member node device or can be pre-stated in the smart contract as a part of the merchandise tracing logic. The merchandise record that storage that is associated with the identity indicated by the appearance data of the target merchandise is performed on can be automatically found by using the smart contract.

In an illustrated implementation, the member node device can generate a transaction based on the found merchandise record, and then submit the transaction to the smart contract to invoke the smart contract and to trigger the merchandise tracing logic stated in the smart contract. Merchandise tracing processing can be automatically performed on the merchandise record by using the smart contract to complete merchandise tracing for the target merchandise.

In another illustrated implementation, the execution logic of the merchandise record that storage that is associated with the identity indicated by the appearance data of the target merchandise is performed on is described above, and can be pre-stated in the smart contract as a part of the merchandise tracing logic. In this case, the member node device can generate a transaction based on the collected appearance data of the target merchandise, and then submit the transaction to the smart contract to invoke the smart contract and to trigger the merchandise tracing logic stated in the smart contract. The merchandise record that storage that is associated with the identity indicated by the appearance data of the target merchandise is performed on can be automatically found, and merchandise tracing processing can be automatically performed on the found merchandise record to complete merchandise tracing for the target merchandise.

For example, in an implementation, an account address of the smart contract can be carried in the generated transaction, and the transaction can be submitted to the smart contract based on the account address as an input of the smart contract to invoke the smart contract, to trigger program code associated with the merchandise tracing logic and stated in the smart contract.

It is worthwhile to note that the transaction used to invoke the smart contract can be automatically generated by the member node device based on the collected merchandise appearance data or the found merchandise record, or can be manually generated by a user.

For example, an operation portal for initiating merchandise tracing can be provided for the common consumer at the client, and the common consumer can trigger the member node device by using the operation portal to automatically generate the transaction used to invoke the smart contract based on the collected merchandise appearance data or the found merchandise record.

Further, when the smart contract is invoked, the member node device can output a merchandise tracing result to the common consumer by using the client. For example, in some exemplary applications, the merchandise tracing result can be output to the common consumer in a form of a prompt message by using the client.

The following describes the technical solutions in detail with reference to specific service scenarios.

In an illustrated merchandise tracing scenario, merchandise tracing for the target merchandise can be merchandise anti-counterfeiting tracing for the target merchandise.

In this case, the merchandise record can be a merchandise production record that is generated by the producer of the merchandise in the consortium blockchain in a merchandise production link and that is signed based on a private key. A public key or a public key list of a legal merchandise producer can be stated in advance in the smart contract. The merchandise tracing logic stated in the smart contract can include execution logic that a signature of the merchandise production record is verified based on the public key of the producer of the target merchandise.

When the common consumer accesses any member node device in the consortium blockchain by using the client to initiate merchandise anti-counterfeiting tracing for the target merchandise, the member node device can collect the appearance data of the target merchandise, search, based on the collected appearance data, for the merchandise production record that is stored and that is associated with the identity indicated by the appearance data, invoke the smart contract to execute the merchandise tracing logic stated in the smart contract, and perform verification on the signature of the merchandise production record based on the public key of the legal producer of the target merchandise; and if the signature verification succeeds, determine that merchandise anti-counterfeiting tracing for the target merchandise succeeds and the target merchandise is a quality merchandise produced by a legal producer. On the contrary, if the signature verification fails, the common consumer can determine that merchandise anti-counterfeiting tracing for the target merchandise fails and the target merchandise is a fake merchandise produced by an illegal producer.

When merchandise anti-counterfeiting tracing for the target merchandise is completed, a tracing result of merchandise anti-counterfeiting tracing can be output to the common consumer by using the client. For example, if merchandise anti-counterfeiting tracing for the target merchandise succeeds, a prompt message “the merchandise you are searching is a quality merchandise” can be output by using the client. On the contrary, if merchandise anti-counterfeiting tracing for the target merchandise fails, a prompt message “the merchandise you are searching is a fake merchandise” can be output by using the client.

In an illustrated merchandise tracing scenario, merchandise tracing for the target merchandise can be merchandise circulation channel tracing for the target merchandise.

In this case, the merchandise record can be a merchandise circulation record that is generated by the merchandise circulation party on the merchandise circulation channel in a merchandise circulation link and that is signed based on a private key.

It is worthwhile to note that when the merchandise circulation channel of the target merchandise includes a plurality of merchandise circulation parties, in an implementation, each merchandise circulation party can generate one merchandise circulation record, perform signature by using a respective private key, and publish the merchandise circulation record to the consortium blockchain for storage that is associated with the identity indicated by the appearance data of the target merchandise. In another implementation, only the first merchandise circulation party in a circulation sequence can generate one merchandise circulation record, and publish the merchandise circulation record to the consortium blockchain for storage that is associated with the identity indicated by the appearance data of the target merchandise. When the target merchandise is circulated to other downstream merchandise circulation parties, the other downstream merchandise circulation parties can successively add a signature to the stored merchandise circulation record.

A public key or a public key list of a legal merchandise circulation party and a legal merchandise circulation sequence can be stated in advance in the smart contract. The merchandise tracing logic stated in the smart contract can include execution logic that a signature of the merchandise circulation record is verified based on the public key of the production circulation party of the target merchandise, and the merchandise circulation sequence of the target merchandise is verified.

When the common consumer accesses any member node device in the consortium blockchain by using the client to initiate merchandise circulation sequence tracing for the target merchandise, the member node device can collect the appearance data of the target merchandise; search, based on the collected appearance data, for the merchandise circulation record that is stored and that is associated with the identity indicated by the appearance data, invoke the smart contract to execute the merchandise tracing logic stated in the smart contract, and perform verification on the signature of the merchandise circulation record based on the public key of the legal merchandise circulation party of the target merchandise.

If the signature verification succeeds, the merchandise circulation sequence of the target merchandise in the plurality of merchandise circulation parties can be further generated based on the merchandise circulation record.

For example, in an illustrated implementation, a timestamp that can indicate the circulation sequence of the target merchandise can be recorded in the merchandise circulation record. For example, the timestamp can be a system timestamp of a member device corresponding to each merchandise circulation party when the merchandise is circulated to the merchandise circulation party, or can be an exact timestamp obtained from a third-party timestamp server. When the merchandise circulation sequence of the target merchandise is generated, the timestamp in the merchandise circulation record can be obtained, and then the merchandise circulation sequence of the target merchandise in the plurality of merchandise circulation parties is generated based on the obtained timestamp.

Further, it can be verified whether the generated merchandise circulation sequence matches a legal circulation sequence of the target merchandise stated in the smart contract. If yes, it can be determined that circulation channel tracing for the target merchandise succeeds, and the target merchandise is circulated to the consumer by using a legal merchandise circulation channel. If no, it can be determined that circulation channel tracing for the target merchandise fails, and the target merchandise is circulated to the consumer by using an illegal merchandise circulation channel.

When merchandise circulation channel tracing for the target merchandise is completed, a tracing result of merchandise circulation channel tracing can be output to the common consumer by using the client. For example, if merchandise circulation channel tracing for the target merchandise succeeds, a prompt message “the merchandise you are searching is from a legal channel” can be output by using the client. On the contrary, if merchandise circulation channel tracing for the target merchandise fails, a prompt message “the merchandise you are searching is from an illegal channel” can be output by using the client.

It can be seen from the previously described implementations that because the blockchain is characterized by historical traceability and cannot be tampered with, the merchandise record generated by the operator of the merchandise in the various traceable links such as merchandise production and circulation can be truly recorded in the blockchain by using such the method, and all merchandise records can be traced in the blockchain. In addition, because the merchandise record is jointly maintained by a plurality of node devices in the blockchain, the merchandise record cannot be tampered with unless most node devices are controlled, ensuring impartiality of the generated merchandise record.

Moreover, because the appearance data of the target merchandise is easy to collect, the appearance data of the target merchandise is registered in the distributed database of the blockchain as the identity of the target merchandise, and storage is performed on the merchandise record generated by the operator of the merchandise in the various traceable links such as merchandise production and circulation that is associated with the identity indicated by the appearance data of the target merchandise, so that when merchandise tracing needs to be performed on the target merchandise, the identity of the target merchandise in the blockchain can be specified by collecting the appearance data of the merchandise. Therefore, the blockchain can be searched based on the specified identity to quickly obtain the corresponding merchandise record, and complete merchandise tracing for the target merchandise, improving tracing efficiency of performing merchandise tracing on the target merchandise.

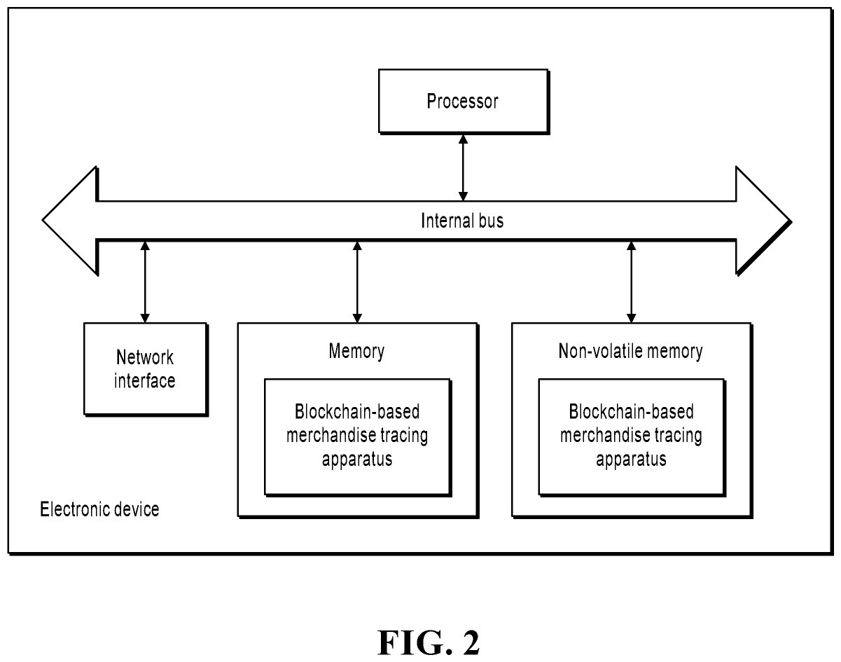

Corresponding to the method implementation, the present specification further provides an implementation of a blockchain-based merchandise tracing apparatus. The implementation of the blockchain-based merchandise tracing apparatus in the present specification can be applied to an electronic device. The apparatus implementation can be implemented by using software, or can be implemented by using hardware or a combination of hardware and software. Using software implementation as an example, a logical apparatus is formed after a processor of the electronic device reads a computer program instruction corresponding to a non-volatile memory to the memory for running. From a perspective of hardware, FIG. 2 is a hardware structural diagram of an electronic device that the blockchain-based merchandise tracing apparatus in the present specification is located in. In addition to a processor, a memory, a network interface, and a non-volatile memory shown in FIG. 2, the electronic device that the apparatus in this implementation is located in usually can include other hardware based on actual functions of the electronic device. Details are omitted here.

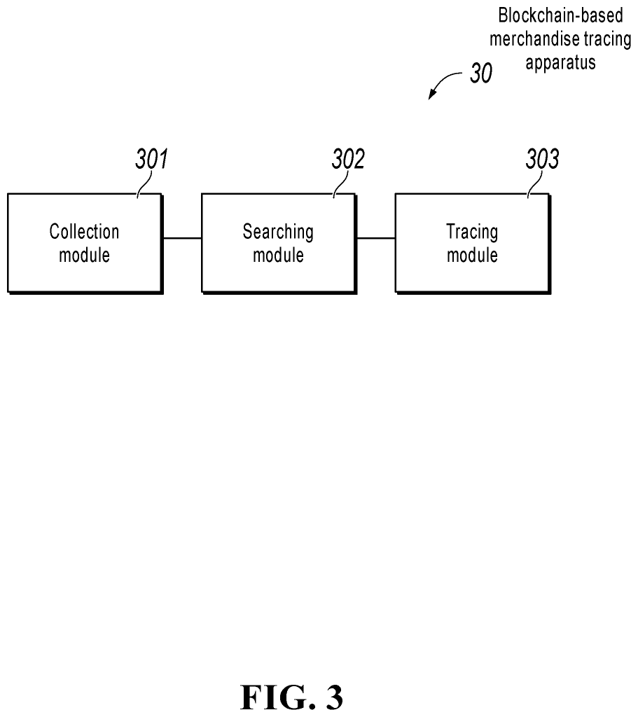

FIG. 3 is a block diagram illustrating a blockchain-based merchandise tracing apparatus, according to an example implementation.

Referring to FIG. 3, the blockchain-based merchandise tracing apparatus 30 can be applied to the electronic device shown in FIG. 2, and includes a collection module 301, a searching module 302, and a tracing module 303.

The collection module 301 is configured to collect appearance data of target merchandise, and register the appearance data of the target merchandise in a distributed database of a blockchain as an identity of the target merchandise.

The searching module 302 is configured to search the distributed database of the blockchain for a merchandise record that is stored and that is associated with the identity indicated by the appearance data of the target merchandise.

The tracing module 303 is configured to perform merchandise tracing processing on the found merchandise record to complete merchandise tracing for the target merchandise.

In this implementation, the apparatus further includes the following: a registration module 304 (not shown in FIG. 3), configured to perform, in the distributed database of the blockchain, storage on the appearance data of the target merchandise that is associated with the identity of the target merchandise that has been registered in the blockchain.

In this implementation, the apparatus further includes the following: an acquisition module 305 (not shown in FIG. 3), configured to obtain a merchandise record that is generated by an operator of the target merchandise and that corresponds to the target merchandise; and a publishing module 306 (not shown in FIG. 3), configured to publish the merchandise record and the appearance data of the target merchandise to the blockchain, to perform, in the distributed database of the blockchain, storage on the merchandise record that is associated with the identity indicated by the appearance data of the target merchandise.

In this implementation, the tracing module 303 is further configured to: invoke a smart contract that corresponds to the target merchandise, execute merchandise tracing logic stated in the smart contract, and perform merchandise tracing processing on the found merchandise record.

In this implementation, the merchandise record includes a merchandise production record signed by a producer of the target merchandise based on a private key, and the merchandise tracing includes merchandise anti-counterfeiting tracing.

The tracing module 303 is further configured to: perform verification on a signature of the merchandise production record based on a public key of the producer of the target merchandise; and determine that merchandise anti-counterfeiting tracing for the target merchandise succeeds if the verification succeeds.

For example, in this implementation, the merchandise record can include a merchandise circulation record signed by a plurality of merchandise circulation parties on a circulation channel of the target merchandise based on a private key, and the merchandise tracing includes merchandise circulation channel tracing.

The tracing module 303 can be further configured to: perform verification on a signature of the merchandise circulation record based on a public key of the plurality of merchandise circulation parties on the circulation channel of the target merchandise; and if the verification succeeds, generate a merchandise circulation sequence of the target merchandise in the plurality of merchandise circulation parties, and verify whether the merchandise circulation sequence matches a predetermined legal circulation sequence; and if yes, determine that merchandise circulation channel tracing for the target merchandise succeeds.

For example, in this implementation, a timestamp used to indicate a circulation sequence of the target merchandise can be recorded in the merchandise circulation record.

The tracing module 303 can be further configured to: obtain the timestamp recorded in the merchandise circulation record; and generate the merchandise circulation sequence of the target merchandise based on the obtained timestamp.

For example, in this implementation, the outer surface of the target merchandise can be sprayed with an optical medium used to solidify the appearance data of the target merchandise.

The collection module 301 can be further configured to: collect, by using a mounted optical sensor, the appearance data of the target merchandise solidified by using the optical medium.

For example, in this implementation, the optical medium can be a nano-optical film.

For example, in this implementation, the blockchain can be a consortium blockchain.

For specific implementation processes of functions and roles of the modules in the apparatus, refer to implementation processes of corresponding steps in the method. Details are omitted here.

Because an apparatus implementation can, for example, correspond to a method implementation, for related parts, refer to partial descriptions in the method implementation. The described apparatus implementation is merely an example. The modules described as separate parts can or cannot be physically separate, and parts displayed as modules can or cannot be physical modules, in other words, can be located in one position, or can be distributed in a plurality of network modules. A part or all of the modules can be selected based on actual needs to achieve the objectives of the solutions of the present specification. The present specification enables a person of ordinary skill in the art to understand and implement the invention as recited in the claims below.

The system, apparatus, or module, described in the implementation can be specifically implemented by a computer chip or an entity, or can be implemented by a product having a certain function. A typical implementation device is a computer, and the computer can be a personal computer, a laptop computer, a cellular phone, a camera phone, a smart phone, a personal digital assistant, a media player, a navigation device, an e-mail receiving and sending device, a game console, a tablet computer, a wearable device, or a combination of any one of these devices.

Corresponding to the method implementation, the present specification further provides an implementation of an electronic device. The electronic device includes a processor and a memory configured to store a machine executable instruction, and the processor and the memory are usually connected to each other by using an internal bus. In another possible implementation, the device can further include an external interface, to communicate with another device or component.

In this implementation, by reading and executing the machine executable instruction that is stored in the memory and that corresponds to control logic of blockchain-based merchandise tracing, the processor is configured to: collect appearance data of target merchandise, and register the appearance data of the target merchandise in a distributed database of a blockchain as an identity of the target merchandise; search the distributed database of the blockchain for a merchandise record that storage that is associated with the identity indicated by the appearance data of the target merchandise is performed on; and perform merchandise tracing processing on the found merchandise record to complete merchandise tracing for the target merchandise.

For example, in this implementation, by reading and executing the machine executable instruction that is stored in the memory and that corresponds to control logic of blockchain-based merchandise tracing, the processor can be configured to: perform, in the distributed database of the blockchain, storage on the appearance data of the target merchandise that is associated with the identity of the target merchandise that has been registered in the blockchain.

For example, in this implementation, by reading and executing the machine executable instruction that is stored in the memory and that corresponds to control logic of blockchain-based merchandise tracing, the processor can be configured to: obtain a merchandise record that is generated by an operator of the target merchandise and that corresponds to the target merchandise; and publish the merchandise record and the appearance data of the target merchandise to the blockchain, to perform, in the distributed database of the blockchain, storage on the merchandise record that is associated with the identity indicated by the appearance data of the target merchandise.

For example, in this implementation, by reading and executing the machine executable instruction that is stored in the memory and that corresponds to control logic of blockchain-based merchandise tracing, the processor can be configured to: invoke a smart contract that corresponds to the target merchandise, execute merchandise tracing logic stated in the smart contract, and perform merchandise tracing processing on the found merchandise record.

For example, in this implementation, the merchandise record can include a merchandise production record signed by a producer of the target merchandise based on a private key, and the merchandise tracing can include merchandise anti-counterfeiting tracing; and by reading and executing the machine executable instruction that is stored in the memory and that corresponds to control logic of blockchain-based merchandise tracing, the processor can be configured to: perform verification on a signature of the merchandise production record based on a public key of the producer of the target merchandise; and determine that merchandise anti-counterfeiting tracing for the target merchandise succeeds if the verification succeeds.

For example, in this implementation, the merchandise record can include a merchandise circulation record signed by a plurality of merchandise circulation parties on a circulation channel of the target merchandise based on a private key, and the merchandise tracing can include merchandise circulation channel tracing; and by reading and executing the machine executable instruction that is stored in the memory and that corresponds to control logic of blockchain-based merchandise tracing, the processor can be configured to: perform verification on a signature of the merchandise circulation record based on a public key of the plurality of merchandise circulation parties on the circulation channel of the target merchandise; and if the verification succeeds, generate a merchandise circulation sequence of the target merchandise in the plurality of merchandise circulation parties, and verify whether the merchandise circulation sequence matches a predetermined legal circulation sequence; and if yes, determine that merchandise circulation channel tracing for the target merchandise succeeds.

For example, in this implementation, a timestamp used to indicate a circulation sequence of the target merchandise can be recorded in the merchandise circulation record; and by reading and executing the machine executable instruction that is stored in the memory and that corresponds to control logic of blockchain-based merchandise tracing, the processor can be configured to: obtain the timestamp recorded in the merchandise circulation record; and generate the merchandise circulation sequence of the target merchandise based on the obtained timestamp.

For example, in this implementation, the outer surface of the target merchandise can be sprayed with an optical medium used to solidify the appearance data of the target merchandise; and by reading and executing the machine executable instruction that is stored in the memory and that corresponds to control logic of blockchain-based merchandise tracing, the processor can be configured to: collect, by using a mounted optical sensor, the appearance data of the target merchandise solidified by using the optical medium.

A person skilled in the art can figure out other implementation solution with respect to the present specification. The present specification is intended to cover any variations, functions, or adaptive changes of the present specification. These variations, functions, or adaptive changes comply with general principles of the present specification, and include common knowledge or a commonly used technical means in the technical field that is not disclosed in the present specification. The specification and the implementations are merely considered as examples, and the actual scope and the spirit of the present specification are pointed out by the following claims.

It should be understood that the present specification is not limited to the accurate structures that are described above and that are shown in the accompanying drawings, and modifications and changes can be made without departing from the scope of the present specification. The scope of the present specification is limited only by the appended claims.

The previous descriptions are merely preferred implementations of the present specification, but are not intended to limit the present specification. Any modification, equivalent replacement, or improvement made without departing from the spirit and principle of the present specification should fall within the protection scope of the present specification.

In the examples described above, the operator can act as an intermediary in a distribution channel for merchandise, such as an agent, a wholesaler, a distributor, or a retailer. The operator can also act as a logistics intermediary for the merchandise. The techniques described above for registering appearance data associated with a merchandise in a distributed database of a blockchain as the identity of the merchandise, and using the identity indicated by the appearance data to search for merchandise records associated with merchandise production and circulation, can also be applied to searching for merchandise records associated with the distribution of the merchandise or the supply chain for the merchandise.

For example, the appearance data of the merchandise can include one or more images of the merchandise taken from various viewing directions, such as front view, rear view, top view, bottom view, left view, right view, and/or perspective view. The appearance data of the merchandise can include one or more images of the merchandise taken under various lighting conditions, such as under visible light, ultraviolet light, and/or infrared light. The appearance data of the merchandise can include one or more two-dimensional images and/or one or more stereoscopic images of the merchandise. The appearance data can include a combination of two or more images of the merchandise. The appearance data can include data derived from one or more images of the merchandise, such as a hash value derived from the one or more images of the merchandise. The appearance data can include a value derived from a mathematical transformation applied to one or more images of the merchandise. For example, the operation portal can include a user interface, such as a graphical user interface.

Appearance data (e.g., image data) of a merchandise can be used as the identity of the merchandise even if the merchandise is not rigid and does not have a fixed appearance. For example, the merchandise can have a specified shape when the merchandise is at rest and not being manipulated by external forces. For example, the merchandise can be a stuffed animal, which can change shape when forces are exerted to squeeze or twist or stretch various parts of the stuffed animal. Nonetheless, the appearance of the stuffed animal at rest is unique, and the appearance data of the stuffed animal can still be used as the identity of the stuffed animal in a blockchain. For example, a piece of garment is not rigid and can have many shapes, e.g., be folded in many ways. The appearance of the garment that is spread out in a specified way is unique and the appearance data of the garment that is spread out in the specified way can still be used as the identity of the garment in the blockchain. For example, a unique identifier can be placed on merchandise that does not have a fixed shape (e.g., a deformable bag of gas, liquid, or gel), and appearance data of the merchandise including the unique identifier can still be used as the identity of the merchandise in the blockchain.

Solidifying the appearance (or appearance data) of the merchandise has the advantage that the appearance data collected at the time of registering the appearance data as an identity or a part of an identity of the merchandise in the blockchain can be substantially matched with the appearance data that are collected at the time that the identity of the merchandise is verified, e.g., in a merchandise tracing process, such as merchandise anti-counterfeiting tracing or merchandise circulation channel tracing process.

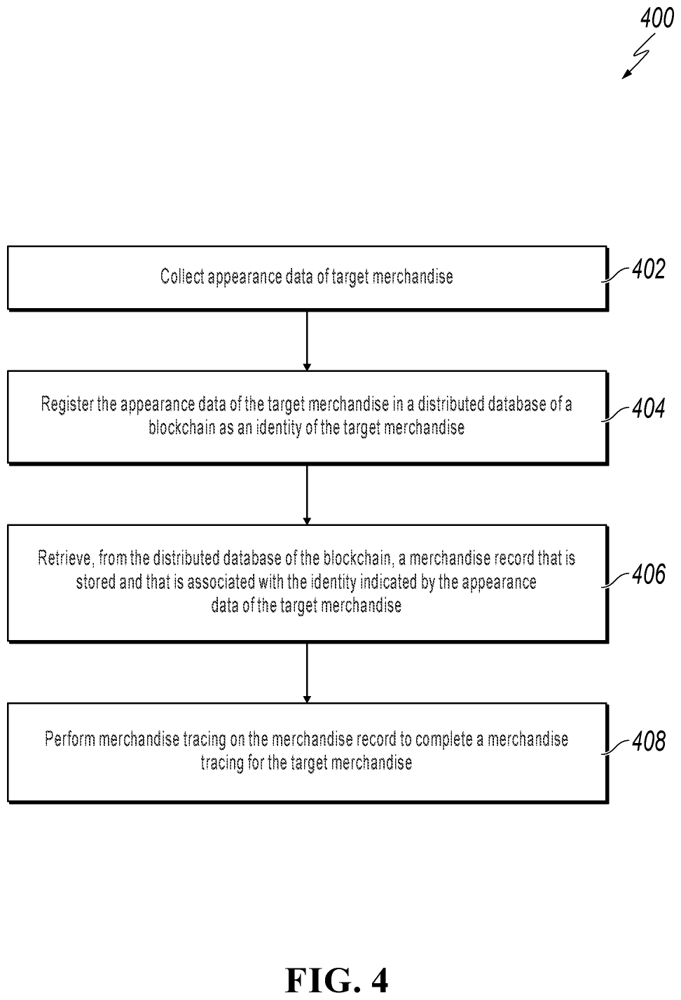

FIG. 4 is a flowchart illustrating an example of a computer-implemented method 400 for blockchain-based merchandise tracing, according to an implementation of the present disclosure For clarity of presentation, the description that follows generally describes method 400 in the context of the other figures in this description However, it will be understood that method 400 can be performed, for example, by any system, environment, software, and hardware, or a combination of systems, environments, software, and hardware, as appropriate In some implementations, various steps of method 400 can be run in parallel, in combination, in loops, or in any order.

At 402, appearance data of target merchandise are collected. From 402, method 400 proceeds to 404.

At 404, the appearance data of the target merchandise are registered in a distributed database of a blockchain as an identity of the target merchandise From 404, method 400 proceeds to 406.

At 406, a merchandise record that is stored and that is associated with the identity indicated by the appearance data of the target merchandise is retrieved from the distributed database of the blockchain From 406, method 400 proceeds to 408.

At 408, merchandise tracing on the merchandise record is performed to complete a merchandise tracing for the target merchandise. After 408, method 400 can stop.

In a general aspect, a computer-implemented method for tracing blockchain-based merchandise is provided. The computer-implemented method includes collecting appearance data of target merchandise; registering the appearance data of the target merchandise in a distributed database of a blockchain as an identity of the target merchandise; retrieving, from the distributed database of the blockchain, a merchandise record that is stored and that is associated with the identity indicated by the appearance data of the target merchandise; and performing merchandise tracing on the merchandise record to complete a merchandise tracing for the target merchandise.

Implementations of the method can include one or more of the following features. Registering the appearance data of the target merchandise in the distributed database can include: performing, in the distributed database of the blockchain, storage on the appearance data of the target merchandise that is associated with the identity of the target merchandise that has been registered in the blockchain.

The method can further include: obtaining a merchandise record that is generated by an operator of the target merchandise and that corresponds to the target merchandise; and publishing the merchandise record and the appearance data of the target merchandise to the blockchain, to perform, in the distributed database of the blockchain, storage on the merchandise record that is associated with the identity indicated by the appearance data of the target merchandise.

Performing merchandise tracing on the merchandise record can include: invoking a smart contract that corresponds to the target merchandise; executing merchandise tracing logic stated in the smart contract; and performing merchandise tracing processing on the merchandise record.

The merchandise record can include a merchandise production record signed by a producer of the target merchandise based on a private key, and wherein the merchandise tracing comprises merchandise anti-counterfeiting tracing.

Performing merchandise tracing on the merchandise record can include: performing verification on a signature of the merchandise production record based on a public key of the producer of the target merchandise; and determining that merchandise anti-counterfeiting tracing for the target merchandise succeeds in response to determining that the verification succeeds.

The merchandise record can include a merchandise circulation record signed by a plurality of merchandise circulation parties on a circulation channel of the target merchandise based on a private key, and wherein the merchandise tracing can include merchandise circulation channel tracing.

Performing merchandise tracing on the merchandise record can include: performing verification on a signature of the merchandise circulation record based on a public key of the plurality of merchandise circulation parties on the circulation channel of the target merchandise; determining whether the verification succeeds; in response to determining that the verification succeeds, generating a merchandise circulation sequence of the target merchandise in the plurality of merchandise circulation parties; determining whether the merchandise circulation sequence matches a predetermined legal circulation sequence; and in response to determining that the merchandise circulation sequence matches the predetermined legal circulation sequence, determining that merchandise circulation channel tracing for the target merchandise succeeds.

A timestamp used to indicate a circulation sequence of the target merchandise can be recorded in the merchandise circulation record.

Generating the merchandise circulation sequence of the target merchandise in the plurality of merchandise circulation parties can include: obtaining the timestamp recorded in the merchandise circulation record; and generating the merchandise circulation sequence of the target merchandise based on the obtained timestamp.

An outer surface of the target merchandise can be sprayed with an optical medium used to solidify the appearance data of the target merchandise.

Collecting the appearance data of the target merchandise can include: collecting, by using a mounted optical sensor, the appearance data of the target merchandise solidified by using the optical medium.

The optical medium can be a nano-optical film.

The blockchain can be a consortium chain.

In another general aspect, an apparatus for tracing blockchain-based merchandise is provided, the apparatus comprising a plurality of modules configured to perform the computer-implemented method of any one of aspects recited above.

Embodiments and the operations described in this specification can be implemented in digital electronic circuitry, or in computer software, firmware, or hardware, including the structures disclosed in this specification or in combinations of one or more of them The operations can be implemented as operations performed by a data processing apparatus on data stored on one or more computer-readable storage devices or received from other sources A data processing apparatus, computer, or computing device may encompass apparatus, devices, and machines for processing data, including by way of example a programmable processor, a computer, a system on a chip, or multiple ones, or combinations, of the foregoing The apparatus can include special purpose logic circuitry, for example, a central processing unit (CPU), a field programmable gate array (FPGA) or an application-specific integrated circuit (ASIC) The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment A program can be stored in a portion of a file that holds other programs or data (for example, one or more scripts stored in a markup language document), in a single file dedicated to the program in question, or in multiple coordinated files (for example, files that store one or more modules, sub-programs, or portions of code) A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer Generally, a processor will receive instructions and data from a read-only memory or a random-access memory or both The essential elements of a computer are a processor for performing actions in accordance with instructions and one or more memory devices for storing instructions and data Generally, a computer will also include, or be operatively coupled to receive data from or transfer data to, or both, one or more mass storage devices for storing data A computer can be embedded in another device, for example, a mobile device, a personal digital assistant (PDA), a game console, a Global Positioning System (GPS) receiver, or a portable storage device Devices suitable for storing computer program instructions and data include non-volatile memory, media and memory devices, including, by way of example, semiconductor memory devices, magnetic disks, and magneto-optical disks The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices The mobile devices can communicate wirelessly (for example, using radio frequency (RF) signals) to various communication networks (described below) The mobile devices can include sensors for determining characteristics of the mobile device's current environment The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors For example, the cameras can include a forward- or rear-facing camera with movable or fixed lenses, a flash, an image sensor, and an image processor The camera can be a megapixel camera capable of capturing details for facial and/or iris recognition The camera along with a data processor and authentication information stored in memory or accessed remotely can form a facial recognition system The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network Examples of interconnected devices are a client and a server generally remote from each other that typically interact through a communication network A client, for example, a mobile device, can carry out transactions itself, with a server, or through a server, for example, performing buy, sell, pay, give, send, or loan transactions, or authorizing the same Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN) The communication network can include all or a portion of the Internet, another communication network, or a combination of communication networks Information can be transmitted on the communication network according to various protocols and standards, including Long Term

Evolution (LTE), 5G, IEEE 802, Internet Protocol (IP), or other protocols or combinations of protocols The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination Operations described and claimed in a particular order should not be understood as requiring that the particular order, nor that all illustrated operations must be performed (some operations can be optional) As appropriate, multitasking or parallel-processing (or a combination of multitasking and parallel-processing) can be performed.

What is claimed is:

1. A computer-implemented method for tracing blockchain-based merchandise, the computer-implemented method comprising:
collecting appearance data of target merchandise;
registering the appearance data of the target merchandise in a distributed database of a blockchain as an identity of the target merchandise;
retrieving, from the distributed database of the blockchain, a merchandise record that is stored and that is associated with the identity indicated by the appearance data of the target merchandise; and
performing merchandise tracing on the merchandise record to complete a merchandise tracing for the target merchandise.

2. The computer-implemented method of claim 1, wherein registering the appearance data of the target merchandise in the distributed database comprises:
performing, in the distributed database of the blockchain, storage on the appearance data of the target merchandise that is associated with the identity of the target merchandise that has been registered in the blockchain.

3. The computer-implemented method of claim 1, further comprising:
obtaining a merchandise record that is generated by an operator of the target merchandise and that corresponds to the target merchandise; and
publishing the merchandise record and the appearance data of the target merchandise to the blockchain, to perform, in the distributed database of the blockchain, storage on the merchandise record that is associated with the identity indicated by the appearance data of the target merchandise.

4. The computer-implemented method of claim 1, wherein performing merchandise tracing on the merchandise record comprises:
invoking a smart contract that corresponds to the target merchandise;
executing merchandise tracing logic stated in the smart contract; and
performing merchandise tracing on the merchandise record.

5. The computer-implemented method of claim 1, wherein the merchandise record comprises a merchandise production record signed by a producer of the target merchandise based on a private key, and wherein the merchandise tracing comprises merchandise anti-counterfeiting tracing.

6. The computer-implemented method of claim 1, wherein the merchandise record comprises a merchandise circulation record signed by a plurality of merchandise circulation parties on a circulation channel of the target merchandise based on a private key, and wherein the merchandise tracing comprises merchandise circulation channel tracing.

7. The computer-implemented method of claim 1, wherein an outer surface of the target merchandise is sprayed with an optical medium used to solidify the appearance data of the target merchandise.

8. A non-transitory, computer-readable medium storing one or more instructions executable by a computer system to perform operations comprising:
collecting appearance data of target merchandise;
registering the appearance data of the target merchandise in a distributed database of a blockchain as an identity of the target merchandise;
retrieving, from the distributed database of the blockchain, a merchandise record that is stored and that is associated with the identity indicated by the appearance data of the target merchandise; and
performing merchandise tracing on the merchandise record to complete a merchandise tracing for the target merchandise.

9. The non-transitory, computer-readable medium of claim 8, wherein registering the appearance data of the target merchandise in the distributed database comprises:
performing, in the distributed database of the blockchain, storage on the appearance data of the target merchandise that is associated with the identity of the target merchandise that has been registered in the blockchain.

10. The non-transitory, computer-readable medium of claim 8, wherein the operations further comprise:
obtaining a merchandise record that is generated by an operator of the target merchandise and that corresponds to the target merchandise; and
publishing the merchandise record and the appearance data of the target merchandise to the blockchain, to perform, in the distributed database of the blockchain, storage on the merchandise record that is associated with the identity indicated by the appearance data of the target merchandise.

11. The non-transitory, computer-readable medium of claim 8, wherein performing merchandise tracing on the merchandise record comprises:
invoking a smart contract that corresponds to the target merchandise;
executing merchandise tracing logic stated in the smart contract; and
performing merchandise tracing on the merchandise record.

12. The non-transitory, computer-readable medium of claim 8, wherein the merchandise record comprises a merchandise production record signed by a producer of the target merchandise based on a private key, and wherein the merchandise tracing comprises merchandise anti-counterfeiting tracing.

13. The non-transitory, computer-readable medium of claim 8, wherein the merchandise record comprises a merchandise circulation record signed by a plurality of merchandise circulation parties on a circulation channel of the target merchandise based on a private key, and wherein the merchandise tracing comprises merchandise circulation channel tracing.

14. The non-transitory, computer-readable medium of claim 8, wherein an outer surface of the target merchandise is sprayed with an optical medium used to solidify the appearance data of the target merchandise.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
collecting appearance data of target merchandise;
registering the appearance data of the target merchandise in a distributed database of a blockchain as an identity of the target merchandise;
retrieving, from the distributed database of the blockchain, a merchandise record that is stored and that is associated with the identity indicated by the appearance data of the target merchandise; and
performing merchandise tracing on the merchandise record to complete a merchandise tracing for the target merchandise.

16. The computer-implemented system of claim 15, wherein registering the appearance data of the target merchandise in the distributed database comprises:
performing, in the distributed database of the blockchain, storage on the appearance data of the target merchandise that is associated with the identity of the target merchandise that has been registered in the blockchain.

17. The computer-implemented system of claim 15, wherein the one or more operations further comprise:
obtaining a merchandise record that is generated by an operator of the target merchandise and that corresponds to the target merchandise; and
publishing the merchandise record and the appearance data of the target merchandise to the blockchain, to perform, in the distributed database of the blockchain, storage on the merchandise record that is associated with the identity indicated by the appearance data of the target merchandise.

18. The computer-implemented system of claim 15, wherein performing merchandise tracing on the merchandise record comprises:
invoking a smart contract that corresponds to the target merchandise;
executing merchandise tracing logic stated in the smart contract; and
performing merchandise tracing on the merchandise record.

19. The computer-implemented system of claim 15, wherein the merchandise record comprises a merchandise production record signed by a producer of the target merchandise based on a private key, and wherein the merchandise tracing comprises merchandise anti-counterfeiting tracing.

20. The computer-implemented system of claim 15, wherein the merchandise record comprises a merchandise circulation record signed by a plurality of merchandise circulation parties on a circulation channel of the target merchandise based on a private key, and wherein the merchandise tracing comprises merchandise circulation channel tracing.
